(19) United States
(12) Patent Application Publication
(10) Pub. No.: US 2007/0083560 A1
(43) Pub. Date: Apr. 12, 2007

(54) System and method for providing online community service for digital content

(75) Inventors: Jong-il Choi, Seoul (KR); Chang-nam Chu, Yongin-si (KR); Do-gyoon Kim, Seongnam-si (KR); Young-sup Kim, Seongnam-si (KR); Hyo-sung Jung, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/545,507

(22) Filed: Oct. 11, 2006

(30) Foreign Application Priority Data
Oct. 11, 2005 (KR) 10-2005-0095632

(51) Int. Cl. G06F 17/00

(52) U.S. Cl. 707/104.1

(57) ABSTRACT

A system and method for providing an online community service is disclosed. The online community provision system includes a played-content information provision server, a client and a community server. The played-content information provision server provides played-content information about digital content. The client selects digital content through a user, requests played-content information about the selected digital content from the played-content information provision server, and receives the played-content information. The community server provides an online community service corresponding to user preferences based on the played-content information to the client at the request of the client.

### CROSS REFERENCE TO RELATED APPLICATION

This application is based on and claims priority from Korean Patent Application No. 10-2005-0095632 filed on Oct. 11, 2005 in the Korean Intellectual Property Office, the disclosure of which is incorporated herein in its entirety by reference.

### BACKGROUND OF THE INVENTION

1. Field of the Invention

Methods, apparatuses and systems consistent with the present invention relate generally to an online community service and, more particularly, to a system and method for providing an online community service for digital content using a convenient method.

2. Description of the Related Art

As digital devices increase in popularity, the size of the market for digital content, such as digital music files, also increases.

Competing services for providing digital content desired by users over the Internet are being provided by a plurality of service providers.

Online communities are also increasing in popularity. Internet users may have conversations about the topics of common interest with, and may acquire necessary information from, persons having the same preferences via online communities. Furthermore, users may purchase desired digital content via online communities.

FIG. 1 is a flowchart illustrating a related process of providing an online community service, with music content being taken as an example.

A user plays music stored in his or her local system using a music file player (S110). Thereafter, the user logs in to a website, which the user is registered at and which provides a music service, via the Internet, and accesses a community service (S120).

After accessing the community service, the user moves to a community menu (S130), and searches a hierarchy of categories regarding a topic of interest in a detailed community classification list (S140).

If a community desired by the user exists, the user accesses the corresponding community, such as a chatroom or a cyber cafe (S150 and S160). Otherwise the user creates and accesses a community (S150 and S170).

The related technology is inconvenient in that users must undertake a large number of steps in order to access desired communities, and users must create communities if communities for desired topics do not exist.

Furthermore, a variety of communities are randomly classified, regardless of user preferences, and are then provided randomly to the users. Therefore, users desiring customized community service are not satisfied with the related art service.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a system and method that enable users to conveniently access desired communities using specified content information.

According to an aspect of the present invention, there is provided a client for providing an online community service, including a user-activity detection module for collecting information about digital content played by each user; a content-information management module for creating a data frame, including user-preference information, based on the played-content information collected by the user-activity detection module; and a communication interface module for transmitting the created data frame, receiving an online community service corresponding to the preference information, and providing the preference information to the user.

According to another aspect of the present invention, there is provided a server for providing an online community service, including a communication interface module for receiving a data frame, including user-preference information for digital content; and a community-creation module for extracting the preference information from the received data frame and searching for an online community service corresponding to the extracted preference information; wherein the communication interface module provides the online community service found by the community-creation module.

According to another aspect of the present invention, there is provided a system for providing an online community service, including a client for providing user-preference information for digital content; and a community server for providing an online community service corresponding to the preference information to the client.

According to another aspect of the present invention, there is provided a system for providing an online community service, including a played-content information provision server for providing information on played content; a client for selecting digital content through a user, requesting played-content information about the selected digital content from the played-content information provision server, and receiving the information on the played content; and a community server for providing an online community service corresponding to user preferences based on the played-content information to the client at the request of the client.

According to another aspect of the present invention, there is provided a method of providing an online community service, including providing user-preference information for digital content; and providing an online community service corresponding to the preference information to the client.

According to another aspect of the present invention, there is provided a method of providing an online community service, including requesting played-content information about digital content selected by a user; receiving the requested played-content information; and requesting an online community service corresponding to user preferences based on the received played-content information.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a flowchart illustrating a related art process of providing an online community service;

FIG. 2 is a block diagram illustrating a system that provides an online community service according to an exemplary embodiment of the present invention;

FIG. 3 is a flowchart illustrating a method of providing an online community service according to an exemplary embodiment of the present invention;

FIG. 4 is a diagram illustrating an example of the structure of a data frame to be transmitted by a client to a community server according to an exemplary embodiment of the present invention;

FIGS. 5A to 5C are diagrams illustrating community menus according to an exemplary embodiment of the present invention;

FIG. 6 is a block diagram illustrating a system of providing an online community service according to another exemplary embodiment of the present invention;

FIG. 7 is a block diagram illustrating a system of providing an online community service according to still another exemplary embodiment of the present invention; and

FIG. 8 is a diagram illustrating an example of information provided by the media server illustrated in FIG. 7.

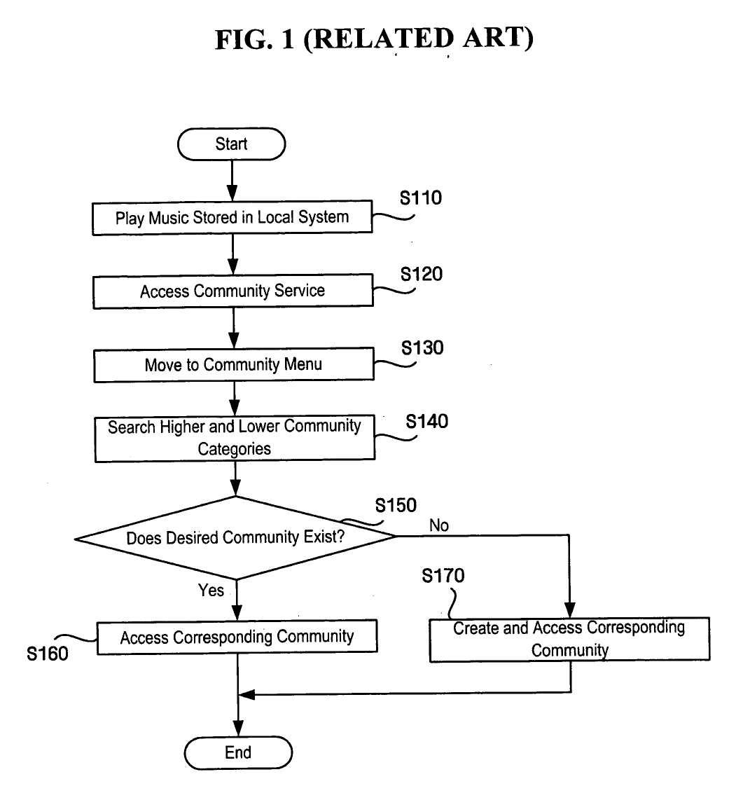

### DETAILED DESCRIPTION OF THE EXEMPLARY EMBODIMENTS

Reference now should be made to the drawings, in which the same reference numerals are used throughout the different drawings to designate the same or similar components.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed in the computer or other programmable apparatus to produce a computer implemented process such that the instructions that are executed on the computer or other programmable apparatus provide steps for implementing the functions specified in the flowchart block or blocks.

Each block of the flowchart illustrations may represent a module, segment, or portion of code, which includes one or more executable instructions for implementing the specified logical functions. It should also be noted that in some alternative implementations that the functions noted in the blocks may occur out of order. For example, two blocks shown in succession may in fact be executed substantially concurrently or the blocks may sometimes be executed in reverse order depending upon the functionality involved.

The system and method for providing an online community service for digital content according to an exemplary embodiment of the present invention are described in detail with reference to the accompanying drawings in the following.

Although the present invention is directed towards an online community service for general digital content, the present invention is described below in conjunction with music content so as to facilitate the description of the present invention. However, the present invention is not limited to music content, but can be applied to other types of digital content.

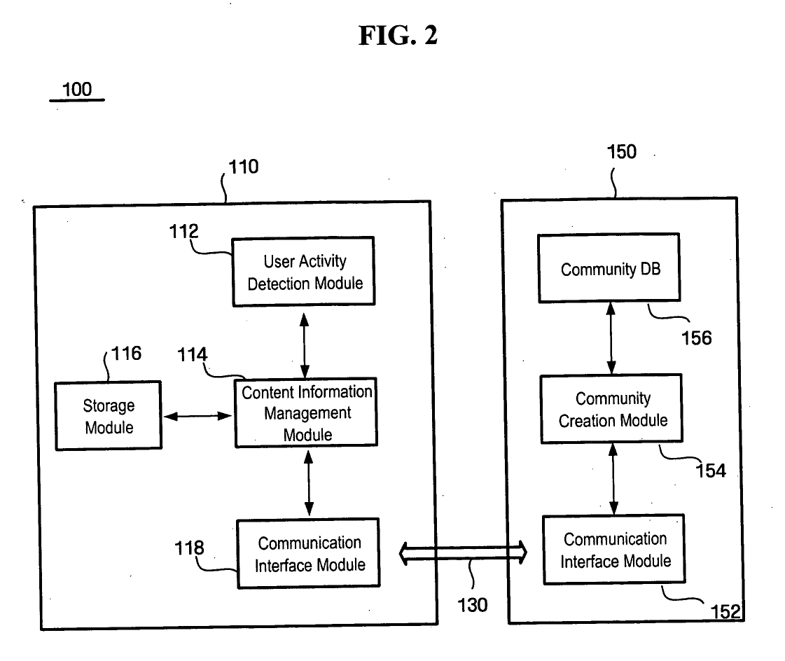

FIG. 2 is a block diagram illustrating a system for providing an online community service according to an exemplary embodiment of the present invention.

With reference to FIG. 2, the online community service provision system 100 includes a client 110 that is manipulated by a user and provides information about user preferences for digital content, particularly music content, and a community server 150 that is connected to the client 110 via a network 130, such as the Internet, and provides a community appropriate for the user preferences in conformity with the information about the user preferences.

The client 110 includes a user-activity detection module 112, a content-information management module 114, a storage module 116, and a communication interface module 118.

The user-activity detection module 112 collects information on played content when the user selects and plays digital content. For example, in the case of music content, the information on played content may include artist information, music title information, and genre information.

Such played-content information may exist in the form of metadata that is added to digital content selected by the user. Furthermore, the played-content information may include information about the number of times the digital content has been played.

The content-information management module 114 stores played-content information collected by the user-activity detection module 112 in the storage module 116, and creates a data frame to be sent to the community server 150, based on the content information.

The storage module 116 may include the played-content information and the user preference class information.

The communication interface module 118 transmits the created data frame to the community server 150, receives an online community service appropriate for the user preferences from the community server 150, and provides the online community service to the user via the output device (not shown) of the client 110.

Meanwhile, the community server 150 includes a communication interface module 152, a community-creation module 154, and a community database 156.

The communication interface module 152 receives the data frame from the client 110, transfers the received data frame to the community-creation module 154, and provides the online community service, provided by the community-creation module 154, to the client 110.

The community-creation module 154 extracts the played-content information from the data frame transferred from the communication interface module 152, and searches the community database 156 for a corresponding online community service based on the extracted, played-content information.

If the corresponding online community service exists in the community database 156, the corresponding community service is provided to the communication interface module 152. Otherwise, an online community service appropriate for the played-content information is created and provided to the communication interface module 152.

The community database 156 stores information about an online community service based on various types of information about played digital content. Such an online community service may exist in the form of a cyber cafe, a cyber chatroom, or an information exchange.

The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

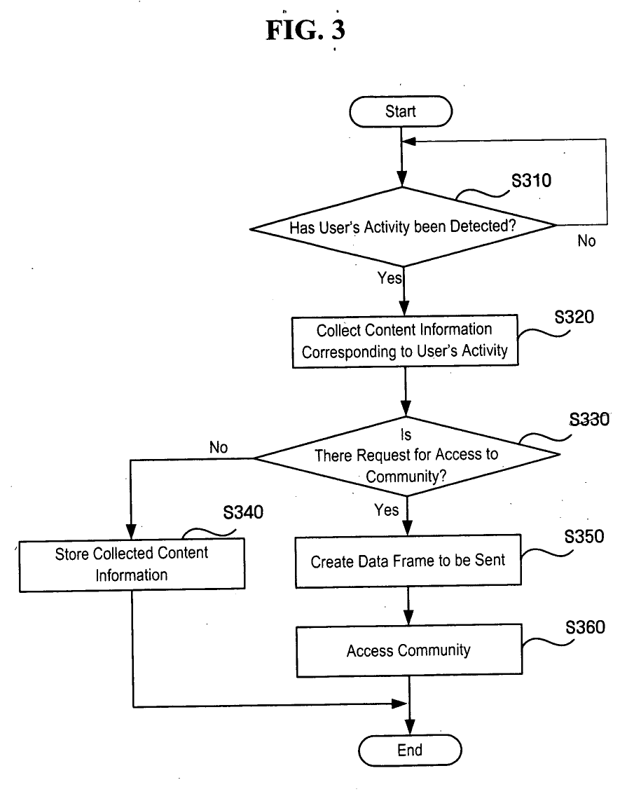

The operations between the client 110 and the community server 150 shown in FIG. 2 are described in detail using a flowchart shown in FIG. 3.

When the user plays digital content in the client 110 using a digital content player, the user-activity detection module 112 detects the user's activity (S310). That is, in the present invention, the term “detection of the user's activity” refers to the detection of the playing of digital content by the user.

When the user's activity is detected by the user-activity detection module 112, that is, for example, when the user plays music using a music file player, the content-information management module 114 collects digital content information corresponding to the user's activity (S320).

In that case, the digital content information is preferably played digital content information. In the case of music content, the played-content information may be information about the genre and title of played music and about an artist.

The played-content information is added to the played music content, and is then provided. Furthermore, the played-content information may include information about the number of times the digital content has been played by the user.

When music content is currently being played and no request for access to an online community is made by the user (S330), the content-information management module 114 stores the collected played-content information in the storage module 116 (S340).

The storage module 116 may include information about a preference class evaluated by the user, in addition to the above-described played-content information.

The preference class information is the information that is obtained by the user evaluating currently played music using a specified method. For example, the user can evaluate music currently being played by scoring the music using numbers ranging from 0 to 10, or by selecting a number of star-shaped symbols. It is preferred that a digital content player, such as the music file player, provide a user interface that allows the user to evaluate the digital content currently being played. The user interface may receive the preference class information from the user, and may store the preference class information in the storage module 116. Furthermore, the user preferences for digital content can be ascertained based on the preference class information and information about digital content selected by the user.

Meanwhile, the user may want more information about the music currently being played, or may want to have conversations with persons who like the music. In this case, the user may want an online community service for the music content currently being played. Furthermore, the user may want an online community service for an artist or genre that the user likes.

In this case, the user requests an online community service for the music content currently being played, or an online community service based on the user preferences, via a popup menu associated with the music file player or via another type of user interface (S330).

The content-information management module 114 creates a data frame to be sent to the community server 150 at the request of the user (S350).

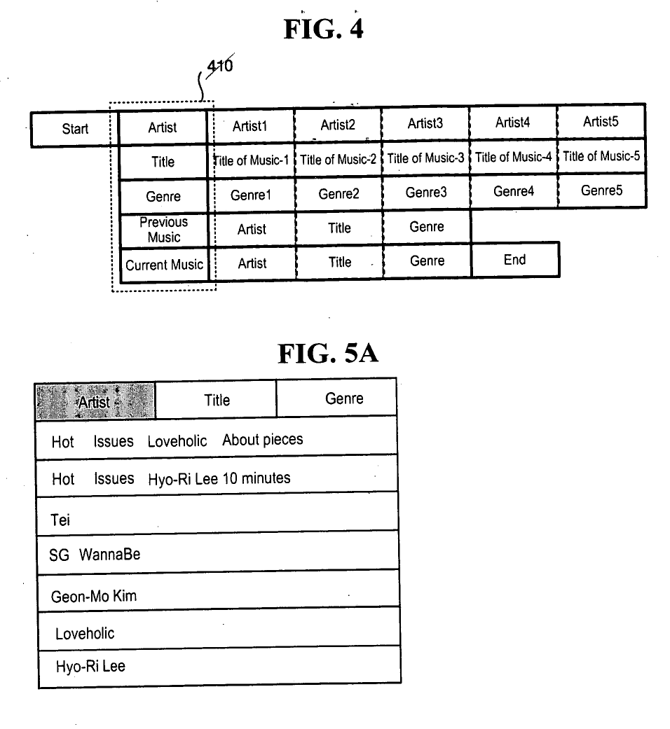

The data frame may be created using played-content information stored in the storage module 116 and information about music content currently being played. An example of the structure of the data frame is illustrated in FIG. 4.

Referring to FIG. 4, the data frame created by the content-information management module 114 includes a “start” field and an “end” field, indicating the start and end of the data frame. Fields in which user preferences information 410 is stored are located between the “start” and “end” fields.

The user-preference information 410, as illustrated in FIG. 4, includes an artist, the title of music, genre, previous music and current music. Pieces of detailed user-preference information based on the user preferences are enumerated after each of the fields. In FIG. 4, five artists, five pieces of music and five genres are enumerated in the order of user preference, and then information about the previous music and current music are included.

The user preferences may be constructed using played-content information stored in the storage module 116, and information about the number of times content has been played and a user preference class can be represented in the user preferences.

Meanwhile, when the user requests an online community service for music content currently being played, it is possible to construct a data frame by including only information about the “current music” field between the “start” field and the “end” field.

Alternatively, when the user requests an online community service according to his or her preferences, it is possible to construct the data frame by including only information about “artist”, “music title” and “genre” fields between the “start” and “end” fields.

When the content-information management module 114 creates the data frame illustrated in FIG. 4, and transfers the data frame to the communication interface module 118, the communication interface module 118 transmits the created data frame to the community server 150.

The communication interface module 152 of the community server 150 receives the data frame, and transmits the data frame to the community-creation module 154.

The community-creation module 154 extracts information about user preferences from the data frame, and searches the community database 150 for an online community service appropriate for the user preferences based on the information about user preferences.

The community database 156 stores information about an online community service based on various pieces of played-content information for digital content. The online community service may be a cafe, chatroom or information exchange type.

If an online community service appropriate for the user-preference information exists in the community database 156, the community-creation module 154 provides the online community service to the communication interface module 152. Otherwise, the community-creation module 154 creates an online community service appropriate for the user-preference information, and provides the online community service to the communication interface module 152.

The user can access a community desired by him or her in such a way that the communication interface module 152 provides the online community service, provided by the community-creation module 154, to the client (S360).

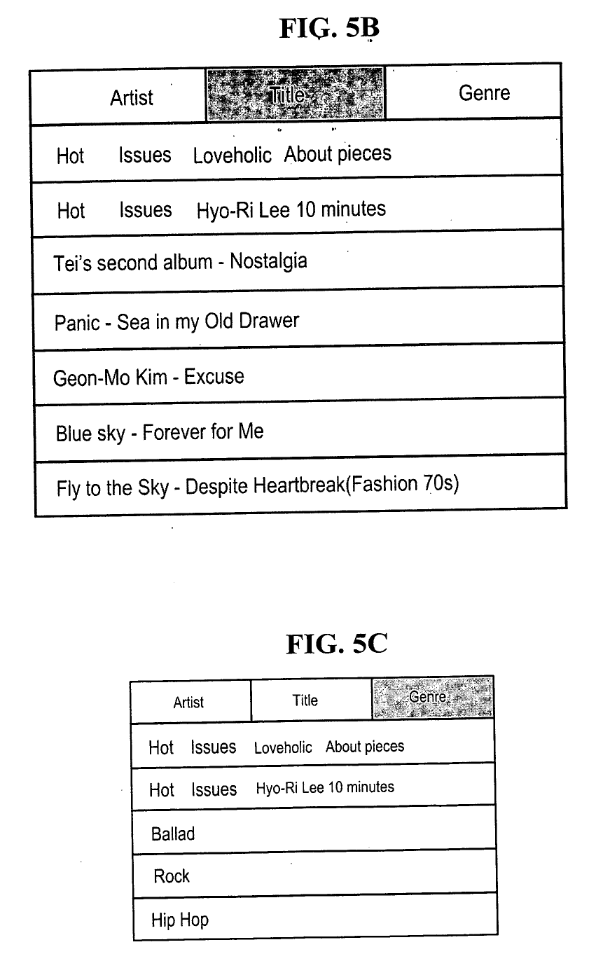

FIGS. 5A to 5C are diagrams illustrating examples of a community menu according to an exemplary embodiment of the present invention. Such a menu can be provided to the client 110 by the community server 150. In FIG. 5A, communities are enumerated according to preference for artist, in FIG. 5B, communities are enumerated according to preference for music, and in FIG. 5C, communities are enumerated according to preference for genre. In each community menu, a first community item “Hot Issues Loveholic About Pieces” and a second community item “Hot Issues Hyo-Ri Lee 10 minutes” are communities that are respectively provided based on music currently being played in the client 110 and music previously played in the client 110.

The community menu that can be provided by the community server 150 to the client 110 is not limited to those illustrated in FIGS. 5A to 5C, but may be any type of menu that takes into account user preferences or liking based on various pieces of played-content information stored in the client 110.

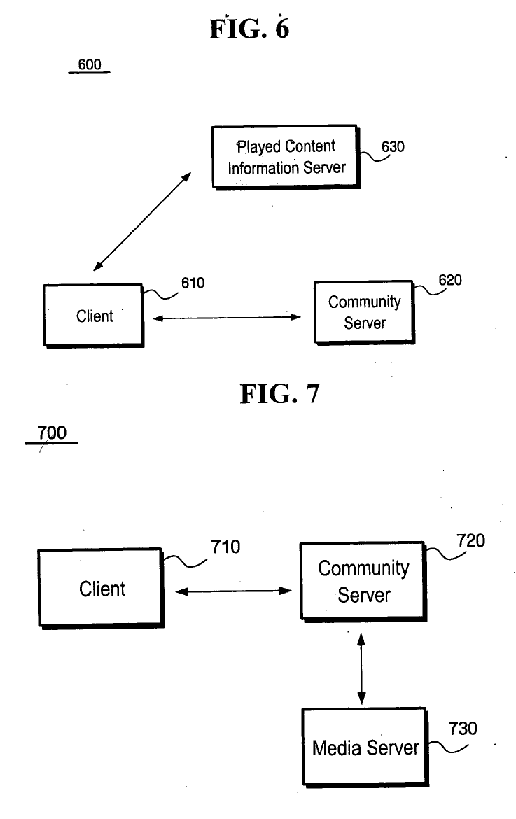

FIG. 6 is a block diagram illustrating a system for providing an online community service according to another exemplary embodiment of the present invention.

Referring to FIG. 6, the online community service provision system 600 includes a client 610, a community server 620, and a played-content information provision server 630. In this case, the client 610 and the community server 620 respectively correspond to the client 110 and the community server 150, which are illustrated in FIG. 2.

When the user plays digital content in the client 610 using a digital content player, the client 610 detects that the digital content is playing and transmits information about the title of the digital content being played, for example, information about the title of music content, to the played-content information provision server 630.

Thereafter, the played-content information provision server 630 provides played-content information about the above-described digital content to the client 610, and the client 610 requests an online community service for digital content currently being played or an online community service based on the user preferences from the community server 620 on the basis of the provided played-content information. The user preferences for digital content may be constructed using the above-described method.

FIG. 7 is a block diagram illustrating a system for providing an online community service according to another exemplary embodiment of the present invention.

Referring to FIG. 7, the online community service provision system 700 includes a client 710, a community server 720 and a media server 730. In this case, the client 710 and the community server 720 respectively correspond to the client 110 and the community server 150, which are illustrated in FIG. 2.

The media server 730 is a server having detailed information about digital content currently being provided, and is connected to the community server 720 via a network.

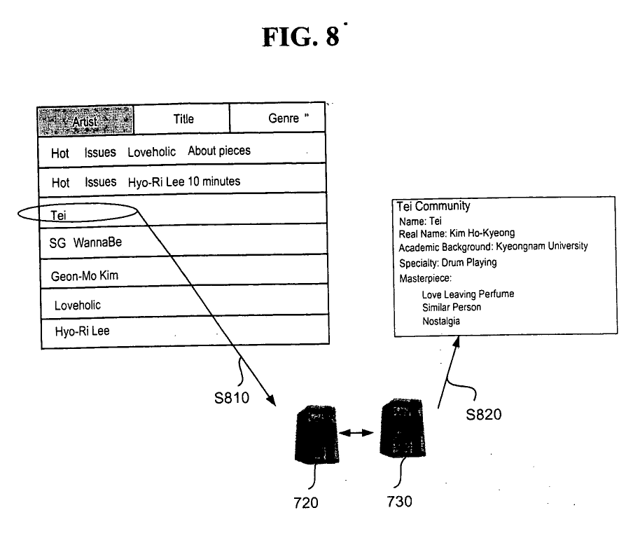

For example, when a user, as illustrated in FIG. 8, clicks on “Tei” in a community menu for artists so as to obtain detailed information about “Tei”, the community server 720 provides an online community service for “Tei” to the client 710, requests the media server 730 to search for the detailed information about “Tei”, and displays the found information in a ‘Tei’ community S820.

In this case, the community server 720 and the media server 730 do not function as separate servers, but function as a single server.

According to the present invention, the user can conveniently use an online community service for digital content through a simplified procedure.

Furthermore, according to the exemplary embodiments of the present invention, an online community service appropriate for the user preferences can be more conveniently provided.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A client device that provides an online community service, the client comprising:
a user-activity detection module which collects information about digital content played by a user;
a content-information management module which creates a data frame, comprising user-preference information based on the information collected by the user-activity detection module; and
a communication interface module which transmits the created data frame, receives an online community service corresponding to the user-preference information, and provides the online community service to the user.

2. The client device of claim 1, wherein the user-preference information comprises information about digital content currently being played.

3. The client device of claim 1, wherein the user-preference information comprises information about a preference class designated by the user.

4. The client device of claim 1, wherein the user-preference information comprises information about a number of times the digital content has been played by the user.

5. The client of claim 1, further comprising a storage module which stores the collected played-content information.

6. A server that provides an online community service, the server comprising:
a communication interface module which receives a data frame, including user-preference information for digital content; and
a community-creation module which extracts the user-preference information from the received data frame, and searches for an online community service corresponding to the extracted user-preference information;
wherein the communication interface module provides the online community service found by the community-creation module to a user.

7. The server of claim 6, wherein the community-creation module creates an online community service if the online community service corresponding to the extracted user-preference information is not found.

8. The server of claim 6, wherein the user-preference information comprises information about digital content currently being played.

9. The server of claim 6, wherein the user-preference information comprises information about a preference class designated by the user.

10. The server of claim 6, wherein the user-preference information comprises information regarding a number of times the digital content has been played by the user.

11. The server of claim 6, further comprising a community database which stores information regarding online community services based on types of information about played digital content,
wherein the community-creation module searches the community database for the online community service corresponding to the extracted user-preference information.

12. A system that provides an online community service, the system comprising:
a client providing user-preference information for digital content; and
a community server providing an online community service corresponding to the user-preference information to the client.

13. The system of claim 12, wherein the user-preference information comprises information about digital content currently being played.

14. The system of claim 12, wherein the user-preference information comprises information about a preference class designated by the user.

15. The system of claim 12, wherein the user-preference information comprises information about a number of times the digital content has been played by the user.

16. The system of claim 12, further comprising a media server for providing detailed information about the digital content to the client.

17. A system that provides an online community service, the system comprising:
a played-content information provision server which provides information on played-content;
a client which selects digital content through a user, requests the information on played-content from the played-content information provision server, and receives the played-content information; and
a community server which provides an online community service corresponding to user preferences based on the played-content information to the client at a request of the client.

18. The system of claim 17, wherein the user preferences comprise information about a preference class designated by the user.

19. The system of claim 17, wherein the user preferences comprise information regarding a number of times the digital content has been played by the user.

20. A method of providing an online community service, comprising:
providing user-preference information for digital content; and
providing an online community service corresponding to the preference information to a client.

21. The method of claim 20, wherein the user-preference information comprises information about digital content currently being played.

22. The method of claim 20, wherein the user-preference information comprises information about a preference class designated by the user.

23. The method of claim 20, wherein the user-preference information comprises information regarding a number of times the digital content has been played by the user.

24. The method of claim 20, further comprising providing detailed information about the digital content to the client.

25. A method of providing an online community service, the method comprising:
requesting played-content information about digital content selected by a user;
receiving the requested played-content information; and
requesting an online community service corresponding to user preferences based on the received played-content information.

26. The method of claim 25, wherein the user preferences comprise information about a preference class designated by the user.

27. The method of claim 25, wherein the user preferences comprise information about a number of times the digital content has been played by the user.

28. A method for providing an online community service, the method comprising:
collecting user-played information of digital content;
creating a data frame based on the user-played content if access to an online community service is requested; and
providing the online community service corresponding to the data frame.

29. The method of claim 28, wherein the user-played information is stored if access to an online community service is not requested.
